(19) United States
(12) Patent Application Publication
(10) Pub. No.: US 2010/0252139 A1
(43) Pub. Date: Oct. 7, 2010

(54) APPARATUS AND METHOD FOR SHAPING ELECTRIC WIRE FOR STATOR COIL OF ELECTRIC ROTATING MACHINE

(75) Inventors: Akito Akimoto, Kariya-shi (JP); Noboru Taniguchi, Kariya-shi (JP); Kazuhiro Nobata, Chiryu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/755,749

(22) Filed: Apr. 7, 2010

(30) Foreign Application Priority Data
Apr. 7, 2009 (JP) 2009-092955

(51) Int. Cl. B21F 35/00; H02K 15/00

(52) U.S. Cl. 140/103; 29/596

(57) ABSTRACT

An electric wire shaping apparatus is disclosed for shaping an electric wire for a stator coil. The electric wire includes a turn portion that is to be located outside of slots of a stator core and a pair of straight portions that are connected by the turn portion and to be respectively received in two of the slots. The interval between the straight portions defines a coil pitch. The apparatus includes a shaping mechanism and a pair of coil pitch keeping mechanisms. The shaping mechanism presses the turn portion of the electric wire in its width-wise direction, thereby shaping the turn portion to have a desired shape. The coil pitch keeping mechanisms respectively press the straight portions of the electric wire toward the inside space between the straight portions, thereby preventing the interval between the straight portions from being changed by the pressing of the turn portion.

### CROSS-REFERENCE TO RELATED APPLICATION

This application is based on and claims priority from Japanese Patent Application No. 2009-92955, filed on Apr. 7, 2009, the content of which is hereby incorporated by reference in its entirety into this application.

### BACKGROUND OF THE INVENTION

1. Technical Field of the Invention

The present invention relates generally to apparatuses and methods for manufacturing electric rotating machines that are used in, for example, motor vehicles as electric motors and electric generators.

More particularly, the invention relates to an apparatus and a method for shaping an electric wire for a stator coil of an electric rotating machine to form coil ends of the stator coil into a desired shape. Hereinafter, the coil ends denote the axial end portions of the stator coil which are located outside of slots of a stator core of the electric rotating machine.

2. Description of the Related Art

Generally, to increase the torque density of an electric rotating machine, it is necessary to improve the space factors of electric wires, which form a stator coil of the machine, by, for example, employing rectangular-cross-section wires as the electric wires. In addition, it is also necessary to minimize the coil ends of the stator coil which have almost no contribution to the generation of torque by the electric rotating machine. Further, the coil ends of the stator coil can be minimized by, for example, transposing the electric wires at the coil ends. Furthermore, the electric wires can be transposed by, for example, providing crank-shaped portions and stepped portions in the coil ends.

Japanese Unexamined Patent Application Publication No. H08-163838 discloses a method of forming both a crank-shaped portion and a stepped portion at the same time in the same part of an electric wire. The crank-shaped portion is provided to shift the electric wire in its width-wise direction. The stepped portion is provided to shift the electric wire in its thickness-wise direction.

On the other hand, a stator coil of an electric rotating machine may be formed by first stacking a plurality of electric wires to form a flat band-shaped electric wire assembly and then rolling the electric wire assembly by a predetermined number of turns into a hollow cylindrical shape. Each of the electric wires includes a plurality of straight portions and a plurality of turn portions. The straight portions extend straight in parallel with each other and are spaced at predetermined intervals. Each of the straight portions is to be received in a corresponding one of slots of a stator core of the electric rotating machine. Each of the turn portions connects one adjacent pair of the straight portions and is to be located outside of the slots of the stator core. In addition, the interval between each adjacent pair of the straight portions defines a coil pitch of the stator coil.

Further, to allow the straight portions of the electric wires forming the stator coil to be smoothly placed into the corresponding slots of the stator core, it is necessary to prevent the intervals between the straight portions of the electric wires from being changed by the shaping of the turn portions.

However, it is unclear whether the intervals between the straight portions of the electric wires can be prevented from being changed if the turn portions are shaped with the method disclosed in Japanese Unexamined Patent Application Publication No. H08-163838.

Furthermore, each of the electric wires may be an insulation-coated electric wire which is comprised of an electric conductor with a substantially rectangular cross section and an electric insulator that covers the electric conductor. In this case, the insulator may bulge in the thickness-wise direction of the electric wire during the shaping of the turn portions of the electric wire. Consequently, the electric wires cannot be densely stacked and rolled to form the stator coil.

In addition, when the thickness of each of the electric wires is reduced in consideration of the bulging of the insulator, it may be possible to densely stack and roll the electric wires to form the stator coil. However, in this case, it may be impossible to supply sufficient current to the electric wires, thereby lowering the torque of the electric rotating machine.

### SUMMARY OF THE INVENTION

According to a first aspect of the present invention, there is provided an electric wire shaping apparatus for shaping a turn portion of an electric wire for a stator coil of an electric rotating machine. The turn portion of the electric wire is to be located outside of slots of a stator core of the electric rotating machine and connects a pair of straight portions of the electric wire. The straight portions of the electric wire extend parallel to each other with a predetermined interval therebetween and are to be respectively received in two of the slots of the stator core; the interval between the straight portions defines a coil pitch of the stator coil. The electric wire shaping apparatus includes a shaping mechanism and a pair of coil pitch keeping mechanisms. The shaping mechanism presses the turn portion of the electric wire in a width-wise direction of the turn portion, thereby shaping the turn portion to have a desired shape. The coil pitch keeping mechanisms respectively press the straight portions of the electric wire toward the inside space between the straight portions, thereby preventing the interval between the straight portions from being changed by the pressing of the turn portion by the shaping mechanism.

With the above configuration, it is possible for the electric wire shaping apparatus to shape the turn portion of the electric wire to have the desired shape, while preventing the interval between the straight portions from being changed. Consequently, the straight portions can be reliably respectively placed into the two slots of the stator core in a subsequent process of assembling the stator coil to the stator core.

In further implementations of the present invention, each of the coil pitch keeping mechanisms may include a force converter and a pressing block. The force converter converts a force transmitted to the coil pitch mechanism in the width-wise direction of the turn portion into a force in a direction toward the inside space between the straight portions. The pressing block presses a corresponding one of the straight portions with the force in the direction toward the inside space between the straight portions.

Each of the coil pitch keeping mechanisms may press a corresponding one of the straight portions of the electric wire to lean toward the inside space between the straight portions by a predetermined angle.

The electric wire shaping apparatus may further include a suppressing mechanism that presses the turn portion of the electric wire in a thickness-wise direction of the turn portion, thereby suppressing the turn portion from bulging in the thickness-wise direction during the pressing of the turn portion by the shaping mechanism. Further, the suppressing mechanism may include a pressing plate that presses the turn portion of the electric wire and at least one elastic member that applies an elastic force to the pressing plate in the thickness-wise direction of the turn portion toward the turn portion.

The shaping mechanism may include a pair of male and female shaping dies and a pressing mechanism. Each of the male and female shaping dies has a shaping surface. The pressing mechanism moves one of the male and female shaping dies toward the other, thereby pressing the turn portion of the electric wire between the shaping surfaces of the male and female shaping dies in the width-wise direction of the turn portion.

The desired shape of the turn portion of the electric wire may be a stepped shape.

The electric wire may be comprised of an electric conductor with a substantially rectangular cross section and an electric insulator that covers the electric conductor.

According to a second aspect of the present invention, there is provided a method of shaping a turn portion of an electric wire for a stator coil of an electric rotating machine. The turn portion of the electric wire is to be located outside of slots of a stator core of the electric rotating machine and connects a pair of straight portions of the electric wire. The straight portions of the electric wire extend parallel to each other with a predetermined interval therebetween and are to be respectively received in two of the slots of the stator core; the interval between the straight portions defines a coil pitch of the stator coil. The method includes: (1) pressing the turn portion of the electric wire in a width-wise direction of the turn portion, thereby shaping the turn portion to have a desired shape; and (2) pressing the straight portions of the electric wire toward the inside space between the straight portions, thereby preventing the interval between the straight portions from being changed by the pressing of the turn portion in the width-wise direction.

With the above method, it is possible to shape the turn portion of the electric wire to have the desired shape, while preventing the interval between the straight portions from being changed. Consequently, the straight portions can be reliably respectively placed into the two slots of the stator core in a subsequent process of assembling the stator coil to the stator core.

According to a third aspect of the present invention, there is provided an electric wire shaping apparatus for shaping a turn portion of an electric wire for a stator coil of an electric rotating machine. The electric wire is comprised of an electric conductor with a substantially rectangular cross section and an electric insulator that covers the electric conductor. The turn portion of the electric wire is to be located outside of slots of a stator core of the electric rotating machine and connects a pair of straight portions of the electric wire which are to be respectively received in two of the slots of the stator core. The electric wire shaping apparatus includes a shaping mechanism and a suppressing mechanism. The shaping mechanism presses the turn portion of the electric wire in a width-wise direction of the turn portion, thereby shaping the turn portion to have a desired shape. The suppressing mechanism presses the turn portion of the electric wire in a thickness-wise direction of the turn portion, thereby suppressing the turn portion from bulging in the thickness-wise direction during the pressing of the turn portion by the shaping mechanism.

With the above configuration, it is possible for the electric wire shaping apparatus to shape the turn portion of the electric wire to have the desired shape, while suppressing the turn portion from bulging in the thickness-wise direction. Consequently, the electric wire can be reliably assembled with other identically-shaped electric wires to form the stator coil.

According to a fourth aspect of the present invention, there is provided a method of shaping a turn portion of an electric wire for a stator coil of an electric rotating machine. The electric wire is comprised of an electric conductor with a substantially rectangular cross section and an electric insulator that covers the electric conductor. The turn portion of the electric wire is to be located outside of slots of a stator core of the electric rotating machine and connects a pair of straight portions of the electric wire which are to be respectively received in two of the slots of the stator core. The method includes: (1) pressing the turn portion of the electric wire in a width-wise direction of the turn portion, thereby shaping the turn portion to have a desired shape; and (2) pressing the turn portion of the electric wire in a thickness-wise direction of the turn portion, thereby suppressing the turn portion from bulging in the thickness-wise direction during the pressing of the turn portion in the width-wise direction.

With the above method, it is possible to shape the turn portion of the electric wire to have the desired shape, while suppressing the turn portion from bulging in the thickness-wise direction. Consequently, the electric wire can be reliably assembled with other identically-shaped electric wires to form the stator coil.

### BRIEF DESCRIPTION OF THE DRAWINGS

The present invention will be understood more fully from the detailed description given hereinafter and from the accompanying drawings of one preferred embodiment of the invention, which, however, should not be taken to limit the invention to the specific embodiment but are for the purpose of explanation and understanding only.

In the accompanying drawings:

FIG. 1 is a schematic perspective view of an electric wire shaping apparatus according to the preferred embodiment of the invention;

FIG. 2 is a cross-sectional view of the electric wire shaping apparatus taken along the line in FIG. 1;

FIG. 3A is a plan view of a pressing block;

FIG. 3B is a plan view of a guiding block;

FIG. 4 is a perspective view showing main components, which include the pressing block shown in FIG. 3A and the guiding block shown in FIG. 3B, of each of coil pitch keeping mechanisms of the electric wire shaping apparatus;

FIG. 5A is a plan view illustrating the initial relative position between the pressing block and guiding block of each of the coil pitch keeping mechanisms;

FIG. 5B is a plan view illustrating the relative position between the pressing block and guiding block during movement of the guiding block toward the pressing block;

FIG. 5C is a plan view illustrating the relative position between the pressing block and guiding block when a turn portion of an electric wire is being shaped by the electric wire shaping apparatus;

FIGS. 6A and 6B are, respectively, front and plan views of part of the electric wire before being shaped by the electric wire shaping apparatus;

FIG. 7 is a plan view illustrating the relative position between a pair of male and female shaping dies of the electric wire shaping apparatus before the shaping of the turn portion of the electric wire by the electric wire shaping apparatus is started;

FIG. 8 is a plan view illustrating the relative position between the male and female shaping dies during the shaping of the turn portion of the electric wire;

FIG. 9 is a plan view illustrating the relative position between the male and female shaping dies when the shaping of the turn portion of the electric wire has just finished;

FIG. 10 is a perspective view illustrating the electric wire shaping apparatus when the shaping of the turn portion of the electric wire has just finished;

FIG. 11 is a cross-sectional view of the electric wire shaping apparatus taken along the line X-X in FIG. 10;

FIG. 12 is a perspective view illustrating the electric wire shaping apparatus when it has returned to its initial state after finishing the shaping of the turn portion of the electric wire;

FIGS. 13A and 13B are, respectively, front and plan views of one section of the electric wire after being shaped by the electric wire shaping apparatus;

FIG. 14A is a cross-sectional view taken along the line XIVA-XIVA in FIG. 13B;

FIG. 14B is a cross-sectional view taken along the line XIVB-XIVB in FIG. 13B; and

FIG. 14C is a cross-sectional view illustrating the effects of a suppressing mechanism of the electric wire shaping apparatus.

### DESCRIPTION OF PREFERRED EMBODIMENT

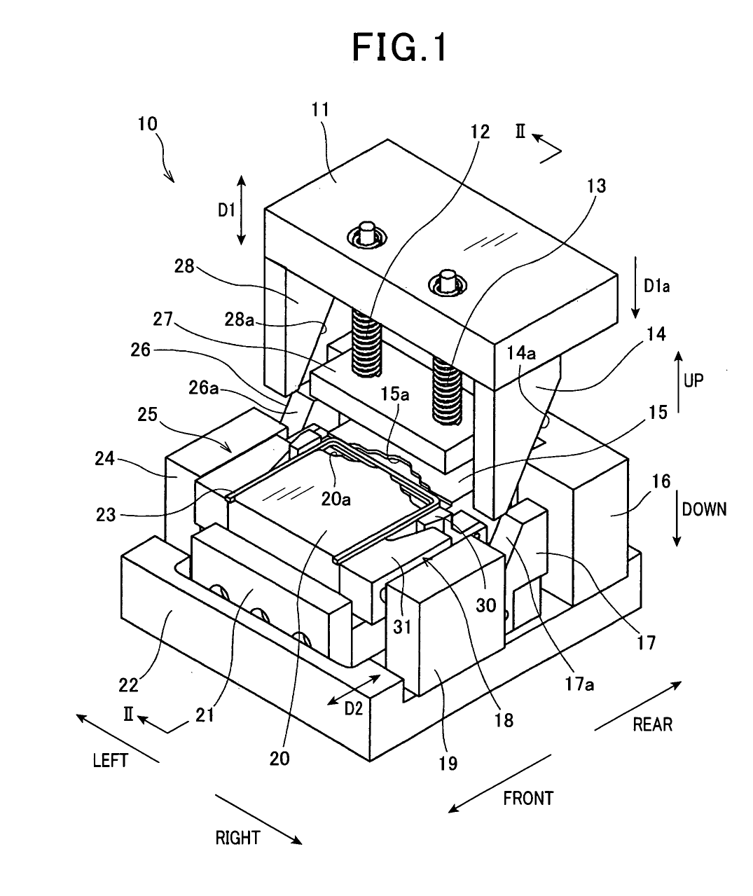

One preferred embodiment of the present invention will be described hereinafter with reference to FIGS. 1-14C.

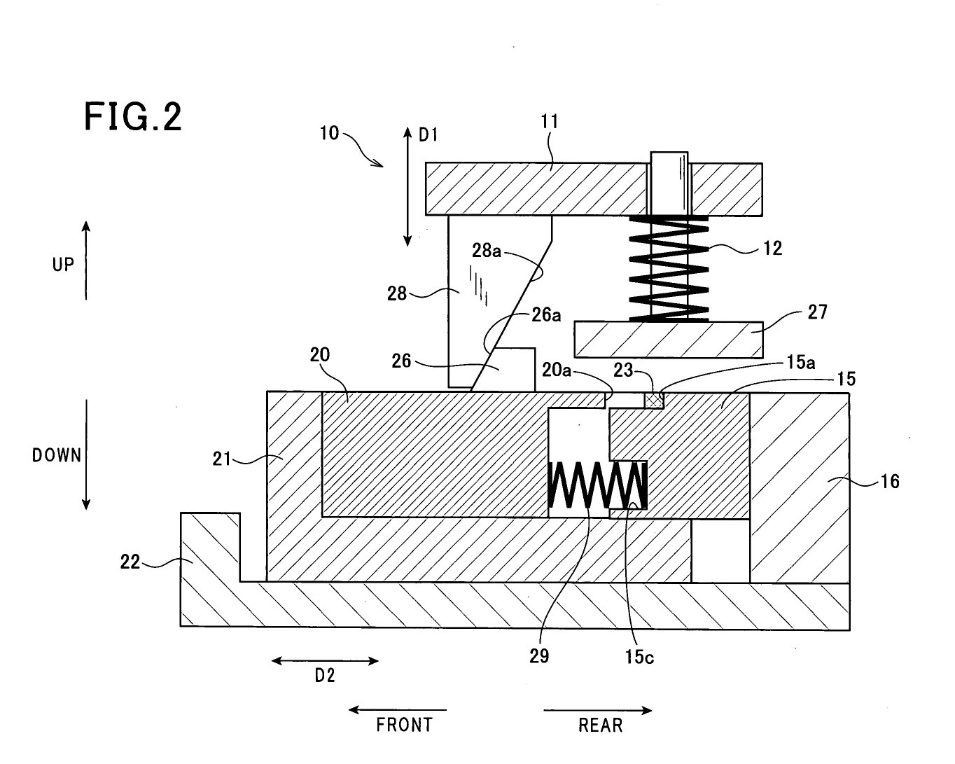

FIGS. 1 and 2 illustrate the overall configuration of an electric wire shaping apparatus 10 according to the preferred embodiment of the invention. It should be noted that for the sake of simplicity, a driving mechanism (e.g., an electric motor or actuator) for driving a moving plate 11 to reciprocate in the vertical direction D1 is omitted from those figures.

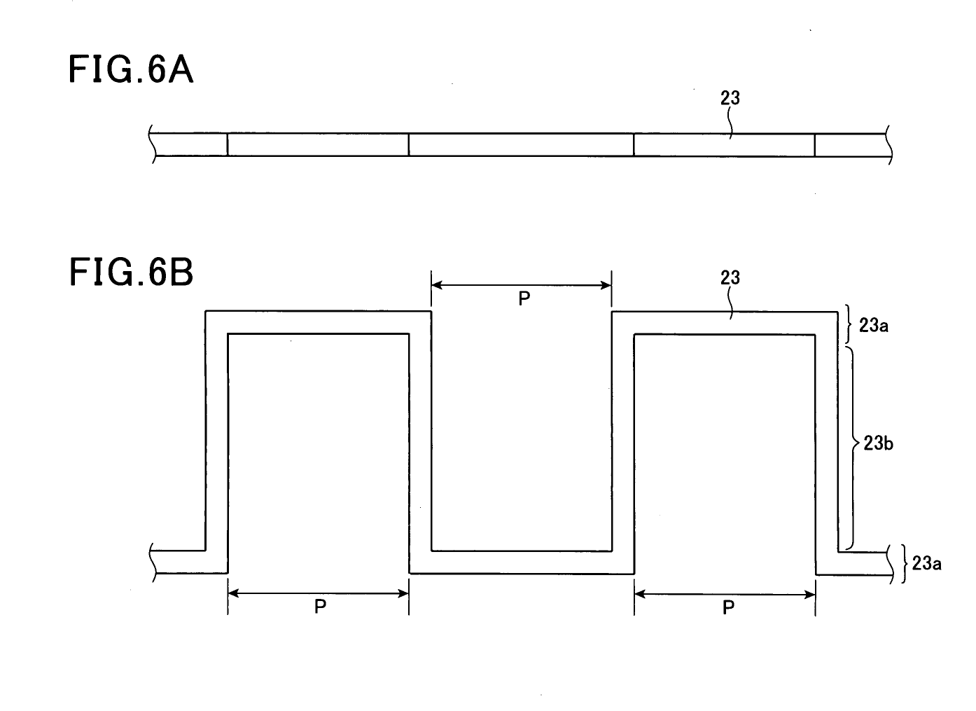

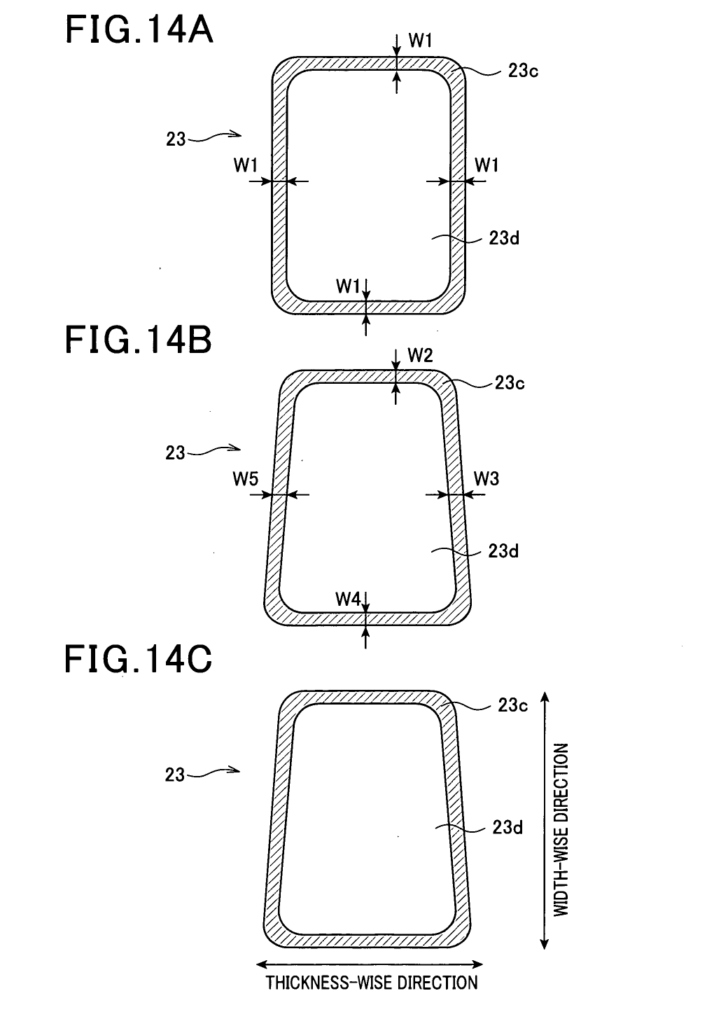

The electric wire shaping apparatus 10 is designed to shape an electric wire 23 for a stator coil of an electric rotating machine. In the present embodiment, referring to FIG. 14A, the electric wire 23 is an insulation-coated electric wire which includes an electric conductor 23d with a substantially rectangular cross section and an electric insulator 23c that covers the electric conductor 23d. The electric conductor 23d is made of, for example, copper. The insulator 23c is made of a resin or enamel, for example PPS (polyphenylene sulfide). The electric wire 23 has a length of, for example, several meters. Moreover, referring to FIGS. 6A-6B, the electric wire 23 includes a plurality of straight portions 23b and a plurality of turn portions 23a. The straight portions 23b extend straight in parallel with each other and are spaced at predetermined intervals. Each of the straight portions 23b is to be received in a corresponding one of slots of a stator core of the electric rotating machine. Each of the turn portions 23a connects one adjacent pair of the straight portions 23b and is to be located outside of the slots of the stator core to make up a part of the coil ends of the stator coil.

In addition, in FIG. 1, there is shown only one section of the electric wire 23; the section includes only one adjacent pair of the straight portions 23b and one of the turn portions 23a which connects the pair of the straight portions 23b. As to the other sections of the electric wire 23, they have the same configuration and are shaped in the same way as the section shown in FIG. 1. Therefore, for the sake of avoiding redundancy, only the process of shaping the single section of the electric wire 23 will be described hereinbelow.

As shown in FIGS. 1 and 2, the electric wire shaping apparatus 10 includes the moving plate 11, a pressing plate 27, elastic members 12 and 13, protruding members 14 and 28, a pair of male and female shaping dies 20 and 15, a base 22, supporting members 16, 19, 24, a moving bed 21, and a pair of coil pitch keeping mechanisms 18 and 25.

The moving plate 11 has the shape of a hexahedron and is restricted from moving in any direction other than the vertical direction D1. As described above, the moving plate 11 is driven by the not-shown driving mechanism to reciprocate in the vertical direction D1.

The pressing plate 27 also has the shape of a hexahedron and is mounted to the lower face of the moving plate 11 via the elastic members 12 and 13. More specifically, each of the elastic members 12 and 13, which are implemented by helical springs in the present embodiment, has one end fixed to the lower face of the moving plate 11 and the other end fixed to the upper face of the pressing plate 27. The pressing plate 27 is provided to press the turn portion 23a of the section of the electric wire 23 in the vertical direction D1 during the shaping of the turn portion 23a by the electric wire shaping apparatus 10.

In addition, in the present embodiment, the pressing plate 27 and the elastic members 12 and 13 together comprise a suppressing mechanism for suppressing the turn portion 23a of the electric wire 23 from bulging in the vertical direction D1 during the shaping of the turn portion 23a.

The protruding members 14 and 28 are directly fixed to the lower face of the moving plate 11. More specifically, the protruding member 14 is fixed to a front and right corner area of the lower face of the moving plate 11 and has an inclined surface 14a inclined to the vertical direction D1. On the other hand, the protruding member 28 is fixed to a front and left corner area of the lower face of the moving plate 11 and has an inclined surface 28a inclined to the vertical direction D1.

The base 22 is disposed below the moving plate 11 and has the supporting members 16, 19, and 24 fixed thereto. More specifically, the supporting member 16 is located on and fixed to a rear end portion of the base 22; the supporting member 19 is located on and fixed to a right end portion of the base 22; and the supporting member 24 is located on and fixed to a left end portion of the base 22. The supporting member 16 has the female shaping die 15 fixed to a front face thereof, so as to support the female shaping die 15 from the rear side.

In a recess which is formed by the base 22, the supporting members 19 and 24, and the female shaping die 15, there is disposed the moving bed 21 in such a manner as to be movable in a horizontal direction D2 (i.e., the forward/backward direction in FIG. 1).

The moving bed 21 has protruding members 17 and 26 fixed thereto. More specifically, the protruding member 17 is fixed to a right end of the moving bed 21 so as to be located under the protruding member 14 fixed to the moving plate 11. The protruding member 17 has an inclined surface 17a that is shaped so as to fit to the inclined surface 14a of the protruding member 14. On the other hand, the protruding member 26 is fixed to a left end of the moving bed 21 so as to be located under the protruding member 28 fixed to the moving plate 11. The protruding member 26 has an inclined surface 26a that is shaped so as to fit to the inclined surface 28a of the protruding member 28.

With the above configuration of the protruding members 14, 28, 17, and 26, when the moving plate 11 is driven by the driving mechanism to reciprocate in the vertical direction D1, the inclined surfaces 14a and 28a of the protruding members 14 and 28 make sliding contact respectively with the inclined surfaces 17a and 26a of the protruding members 17 and 26, thereby causing the moving bed 21 to reciprocate in the horizontal direction D2. In other words, with the sliding contact between the inclined surfaces 14a and 17a and between the inclined surfaces 28a and 26a, the transmitting direction of the power applied by the driving mechanism is changed from the vertical direction D1 to the horizontal direction D2.

On a central portion of the moving bed 21, there is fixed the male shaping die 20. Moreover, the coil pitch keeping mechanisms 18 and 25 are arranged on the moving bed 21 so as to be respectively located on the right and left sides of the male shaping die 20.

The male shaping die 20 has a convex shaping surface 20a, whereas the female shaping die 15 has a concave shaping surface 15a. As to be described in detail later, the electric wire shaping apparatus 10 shapes the turn portion 23a of the electric wire 23 by pressing it between the shaping surfaces 20a and 15a of the male and female shaping dies 20 and 15. In addition, a helical spring 29 is interposed between the male and female shaping dies 20 and 15 in the horizontal direction D2.

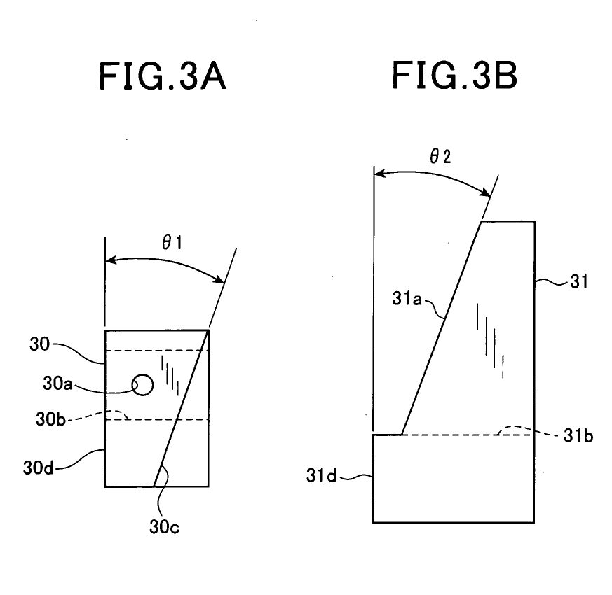

Next, the configuration of the coil pitch keeping mechanisms 18 and 25 will be described in detail with reference to FIGS. 3A-5C.

In the present embodiment, each of the coil pitch keeping mechanisms 18 and 25 is comprised of a pressing block 30, a guiding block 31, a pin 32, a fixing plate 33, a helical spring 34, and a fixing member 35. It should be noted that the coil pitch keeping mechanisms 18 and 25 have the same configuration except that the shapes thereof are mirror images of each other. Therefore, for the sake of avoiding redundancy, only the configuration of the coil pitch keeping mechanism 18 will be described below.

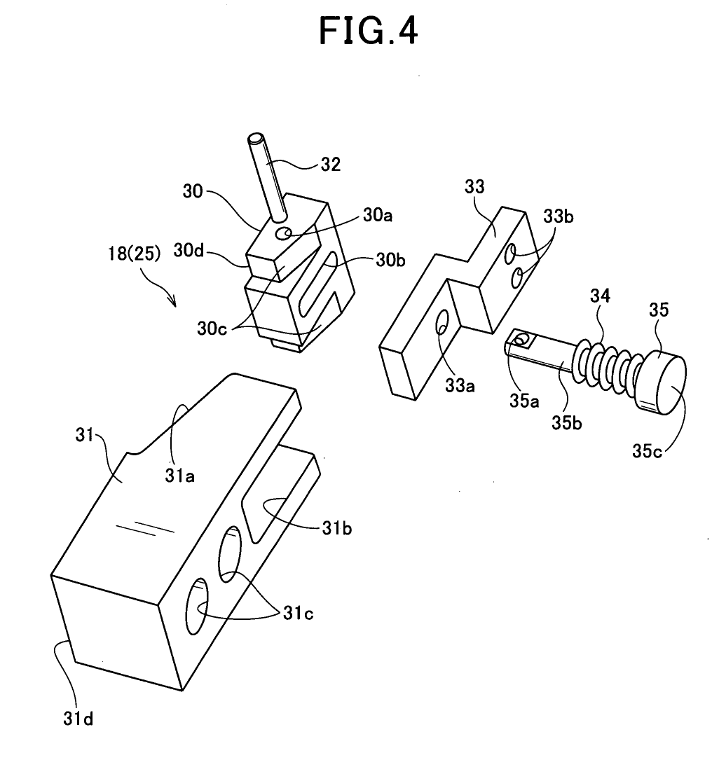

The pressing block 30 has, as shown in FIG. 3A and 4, a pinhole 30a, an elongated through-hole 30b, an oblique surface 30c, and a side surface 30d. The oblique surface 30c is shaped so as to be oblique to the side surface 30d at an oblique angle θ1.

The guiding block 31 has, as shown in FIG. 3B and 4, an oblique surface 31a, a recess 31b with a substantially U-shaped cross section, fixing holes 31c, and a side surface 31d. The oblique surface 31a is so shaped as to be oblique to the side surface 31d at an oblique angle θ2.

In the present embodiment, the oblique angle θ1 of the oblique surface 30c is set to be smaller than the oblique angle θ2 of the oblique surface 31a. More specifically, (θ2−θ1) is preferably set to be in the range of 0.5° to 1.5°. In addition, the oblique angles θ1 and θ2 may be suitably set according to the materials, widths and thicknesses of the electric conductor 23d and insulator 23c of the electric wire 23, and also to the lengths of the turn portions 23a and straight portions 23b of the electric wire 23.

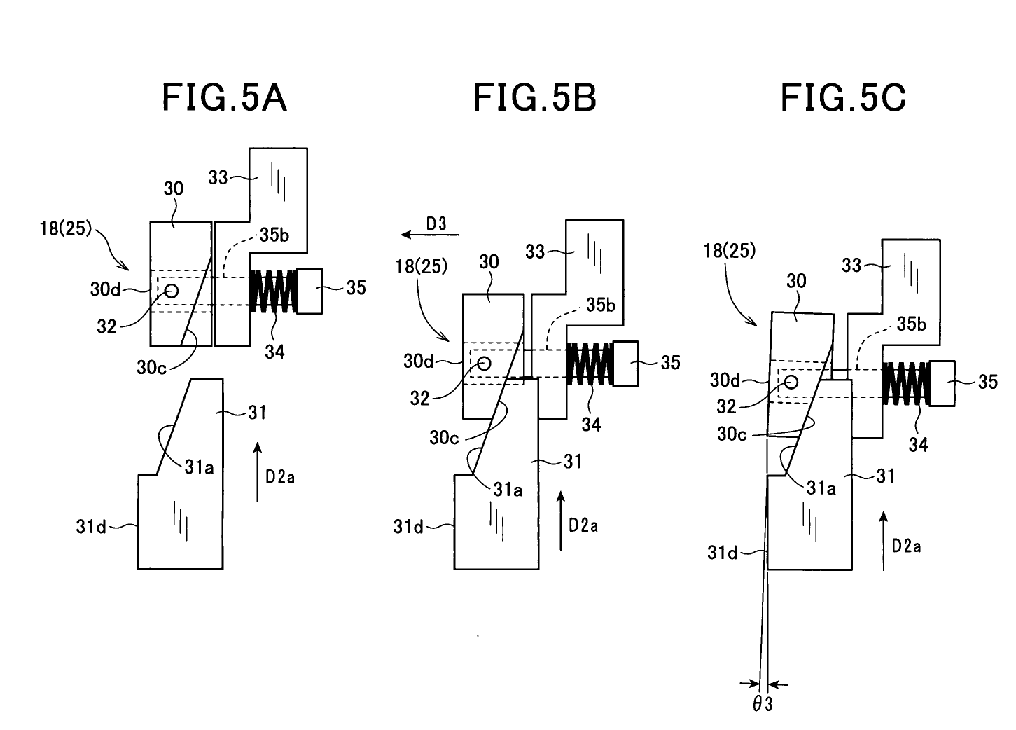

The pressing block 30 is fixed to one side surface of the female shaping die 15, as shown in FIG. 1. More specifically, in the present embodiment, the pressing block 30 is fixed to the side surface of the female shaping die 15 via the fixing plate 33 and the fixing member 35. As shown in FIG. 4, the fixing plate 33 is crank-shaped and has a through-hole 33a and fixing holes 33b. The fixing plate 33 is fixed to the side surface of the female shaping die 15 by means of, for example, bolts (not shown); the bolts extend respectively through the fixing holes 33b of the fixing plate 33 and are fastened to the side surface of the female shaping die 15. The fixing member 35 is bolt-shaped to include a shaft 35b and a head portion 35c. The fixing member 35 also has the spring 34 disposed on the shaft 35b and a pinhole 35a that is formed in an end portion of the shaft 35b to extend perpendicular to the longitudinal direction of the shaft 35b. In fixing the pressing block 30, the shaft 35b of the fixing member 35 is first inserted in both the through-hole 33a of the fixing plate 33 and the through-hole 30b of the pressing block 30, so that the spring 34 is interposed between the fixing plate 33 and the head portion 35c of the fixing member 35. Then, the pin hole 32 is inserted in both the pinhole 30a of the pressing block 30 and the pinhole 35a of the fixing member 35, with the spring 34 being compressed between the fixing plate 33 and the head portion 35c of the fixing member 35. Consequently, the pressing block 30 is fixed to the fixing plate 33 under the elastic force of the spring 34, as shown in FIG. 5A, thereby being also fixed to the side surface of the female shaping die 15 via the fixing plate 33.

On the other hand, the guiding block 31 is fixed to one side surface of the male shaping die 20, as shown FIG. 1. More specifically, the guiding block 31 is fixed to the side surface of the male shaping die 20 by means of, for example, bolts (not shown); the bolts extend respectively through the fixing holes 31c of the guiding block 31 and are fastened to the side surface of the male shaping die 20.

FIG. 5A illustrates the initial relative position between the pressing block 30 and the guiding block 31.

As shown in FIG. 5A, the pressing block 30 and the guiding block 31 are initially located away from each other with the side surface 30d of the pressing block 30 parallel to the side surface 31d of the guiding block 31.

FIG. 5B illustrates the relative position between the pressing block 30 and the guiding block 31 during movement of the guiding block 31 toward the pressing block 30.

As shown in FIG. 5B, after the shaping process of the electric wire shaping apparatus 10 is started, the guiding block 31 is moved, from the initial position shown in FIG. 5A, toward the pressing block 30 (i.e., in the horizontal direction D2a), thereby bringing the oblique surface 31a of the guiding block 31 into sliding contact with the oblique surface 30c of the pressing block 30.

FIG. 5C illustrates the relative position between the pressing block 30 and the guiding block 31 when the turn portion 23a of the electric wire 23 is being shaped by the electric wire shaping apparatus 10.

As shown in FIG. 5C, during the shaping of the turn portion 23a of the electric wire 23, the side surface 30d of the pressing block 30 makes an angle θ3, which is equal to (θ2−θ1), with the side surface 31d of the guiding block 31. That is, the side surface 30d of the pressing block 30 is deviated from the horizontal direction D2a by the angle θ3, so as to more reliably prevent the interval between the straight portions 23b from being changed by the shaping of the turn portion 23a.

After having described the configuration of the electric wire shaping apparatus 10 according to the present embodiment, the process of the apparatus 10 for shaping the electric wire 23 will be described hereinafter.

FIGS. 6A and 6B show part of the electric wire 23 before being shaped by the electric wire shaping apparatus 10. As shown in those figures, the electric wire 23 is originally rectangular wave-shaped with the turn portions 23a extending straight perpendicular to the straight portions 23b. The interval P between each adjacent pair of the straight portions 23b, which defines a coil pitch of the stator coil, is set to a desired value. If the interval P is deviated from the desired value due to the shaping process, the straight portions 23b cannot be respectively placed into desired slots of the stator core during a subsequent process of assembling the stator coil to the stator core. Therefore, it is essential to prevent the interval P from being changed by the shaping process.

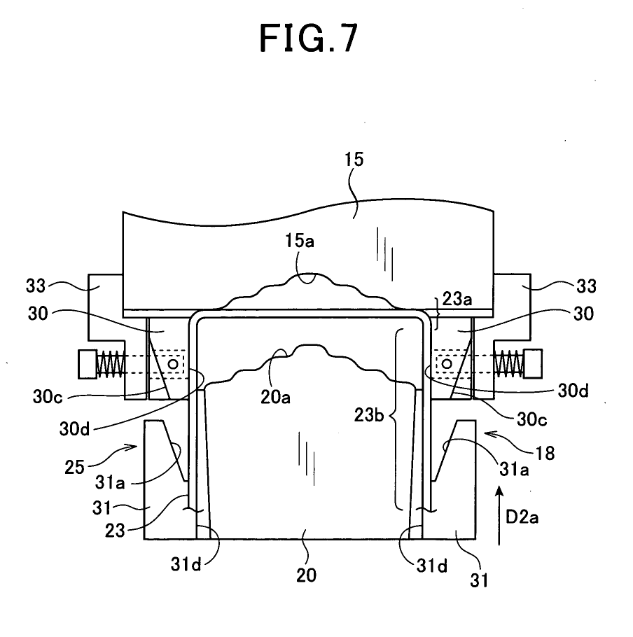

In the shaping process, one section of the electric wire 23 is first set to the electric wire shaping apparatus 10 as shown in FIGS. 1, 2, and 7. As described previously, the section includes only one adjacent pair of the straight portions 23b and one of the turn portions 23a which connects the pair of the straight portions 23b. In addition, in this stage, all of the side surfaces 30d of the pressing blocks 30 and the side surfaces 31d of the guiding block 31 are located parallel to the horizontal direction D2a as shown in FIG. 7.

Then, the driving mechanism drives the moving plate 11 to move downward (i.e., in the direction D1a shown in FIG. 1), causing the inclined surfaces 14a and 28a of the protruding members 14 and 28 to respectively make sliding contact with the inclined surfaces 17a and 26a of the protruding members 17 and 26 and thereby causing the moving bed 21 to move backward. Consequently, the male shaping die 20 and the guiding blocks 31 of the coil pitch keeping mechanisms 18 and 25 are also moved backward (i.e., in the direction D2a shown in FIG. 7) along with the moving bed 21.

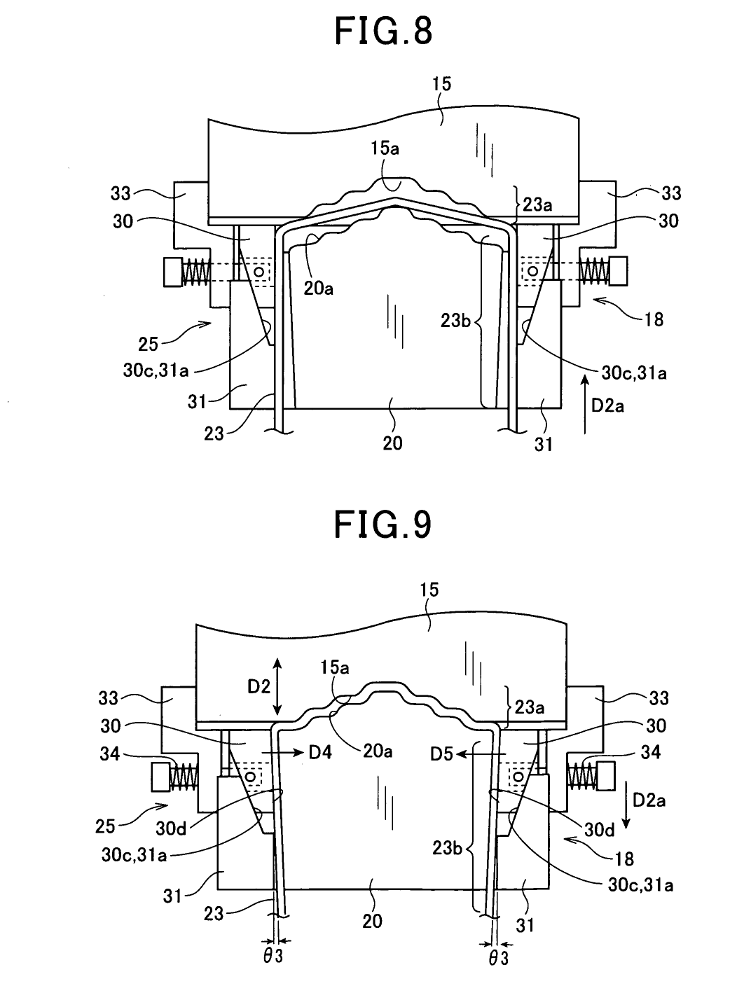

During the backward movement of the male shaping die 20 and the guiding blocks 31, the turn portion 23a of the electric wire 23 is first bent into a triangular shape as shown in FIG. 8, and the oblique surfaces 31a of the guiding blocks 31 are brought into sliding contact with the oblique surfaces 30c of the pressing blocks 30.

When the male shaping die 20 has been moved backward to reach a shaping finish position as shown in FIGS. 9-11, the turn portion 23a of the electric wire 23 is pressed between the male and female shaping dies 20 and 15, thereby being imparted a desired shape by the shaping surfaces 20a and 15a of the shaping dies 20 and 15.

More specifically, as shown in FIG. 9, the turn portion 23a of the electric wire 23 is pressed in its width-wise direction between the shaping surface 20a of the male shaping die 20 and the shaping surface 15a of the female shaping die 15, thereby being bent to have a stepped shape.

That is to say, the process of the electric wire shaping apparatus 10 for shaping the electric wire 23 includes a step of pressing the turn portion 23a of the electric wire 23 in its width-wise direction, thereby shaping the turn portion 23a to have the stepped shape.

Moreover, during the shaping process, with the sliding contact between the oblique surfaces 31a of the guiding blocks 31 and the oblique surfaces 30c of the pressing blocks 30, the pressing blocks 30 are moved respectively in the directions D4 and D5 shown in FIG. 9 against the elastic forces of the springs 34, thereby pressing the straight portions 23b of the electric wire 23 inward. More specifically, in FIG. 9, the left-side straight portion 23b is pressed by the pressing block 30 of the coil pitch keeping mechanism 25 in the direction D4, while the right-side straight portion 23b is pressed by the pressing block 30 of the coil pitch keeping mechanism 18 in the direction D5. Consequently, with the pressing forces of the pressing blocks 30, the interval P between the straight portions 23b and thus the coil pitch of the stator coil defined by the interval P can be prevented from being changed by the pressing of the turn portion 23a.

That is to say, the process of the electric wire shaping apparatus 10 for shaping the electric wire 23 includes a step of pressing the straight portions 23b of the electric wire 23 inward, thereby preventing the interval P between the straight portions 23b from being changed by the pressing of the turn portion 23. It should be noted that the step of pressing straight portions 23b does not necessary start and end at the same times with the step of pressing the turn portion 23a.

In addition, considering the springback of the straight is portions 23b of the electric wire 23, the coil pitch keeping mechanisms 18 and 20 are so configured that during the pressing of the turn portion 23a, the side surfaces 30d of the pressing blocks 30 lean toward the inside space between the straight portions 23b by the angle θ3. Consequently, during the pressing of the turn portion 23a, the straight portions 23b of the electric wire 23 are pressed by the side surfaces 31d of the pressing blocks 31 to lean inward by the angle θ3. As a result, the interval P between the straight portions 23b can be more reliably prevented from being changed by the pressing of the turn portion 23a.

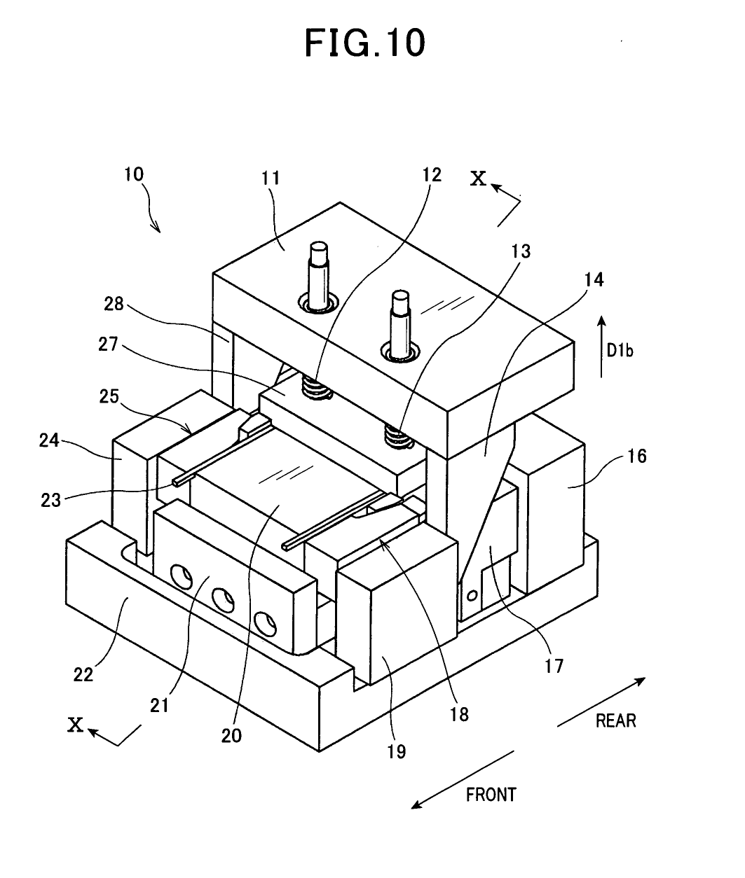

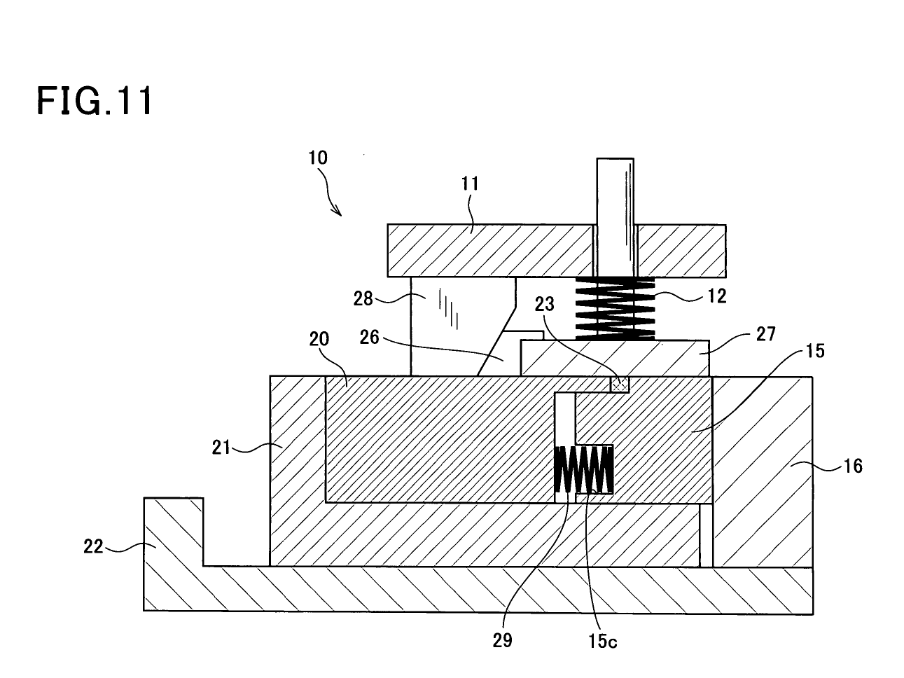

Furthermore, during the shaping process, as shown in FIGS. 10 and 11, the pressing plate 27 presses, under the elastic forces of the elastic members 12 and 13, the turn portion 23a of the electric wire 23 in its thickness-wise direction, thereby suppressing the turn portion 23a from bulging in the thickness-wise direction.

That is to say, the process of the electric wire shaping apparatus 10 for shaping the electric wire 23 also includes a step of pressing the turn portion 23a of the electric wire 23 in its thickness-wise direction, thereby suppressing the turn portion 23a from bulging in the thickness-wise direction.

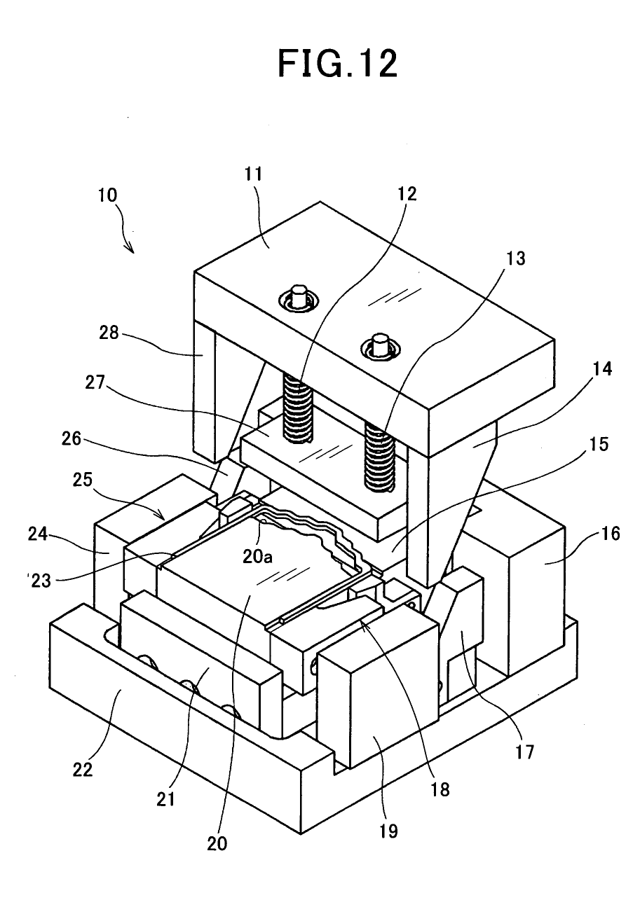

After having finished the shaping of the turn portion 23a of the electric wire 23, the drive mechanism drives the moving plate 11 to move upward (i.e., in the direction D1b in FIG. 10), thereby causing the moving bed 21 to move forward. Consequently, the male shaping die 20 and the guiding blocks 31 of the coil pitch keeping mechanisms 18 and 25 are also moved forward (i.e., in the direction D2b in FIG. 9) along with the moving bed 21, until returning to their initial rest positions as shown in FIG. 12.

Then, the electric wire 23 is removed from the electric wire shaping apparatus 10, and the entire shaping process is thus completed.

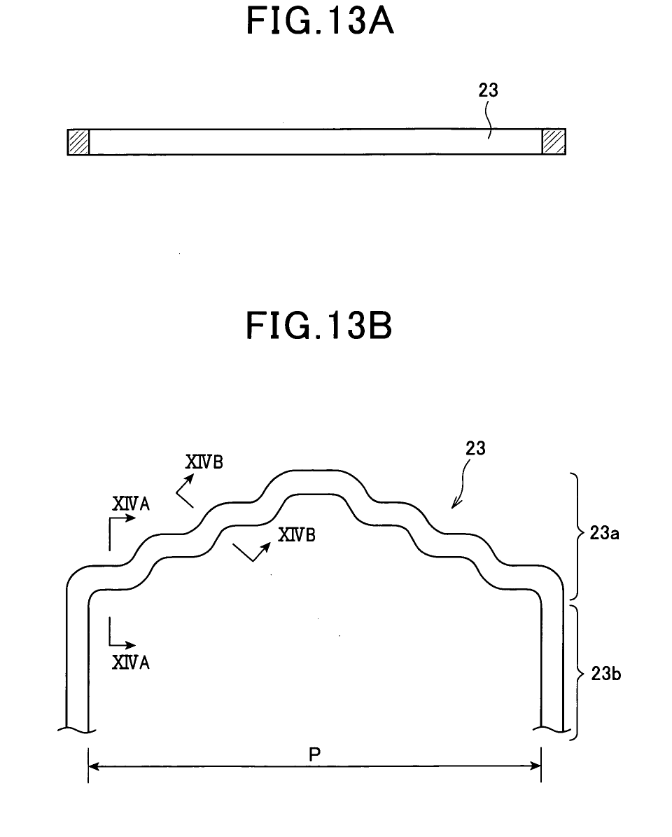

FIGS. 13A-13B show the section of the electric wire 23 after being shaped by the electric wire shaping apparatus 10. As shown in those figures, the turn portion 23a of the electric wire 23 is shaped, by the shaping process, to have the stepped shape. Moreover, the interval P between the straight portions 23b, which defines a coil pitch of the stator coil, is kept unchanged by the coil pitch keeping mechanisms 18 and 25.

Referring now to FIG. 14A, for each of straight parts of the turn portion 23a, the insulator 23c have almost the same thickness W1 for all of the four side surfaces of the straight part.

On the other hand, referring to FIG. 14B, for each of bent parts of the turn portion 23a, the insulator 23c have thicknesses W2, W3, W4, W5 respectively for the four side surfaces of the bent part. The width W2 on the bending outside of the bent part is smaller than the width W4 on the bending inside of the bent part. This is because during the shaping process, the insulator 23c is expanded in the length-wise direction and thinned in the width-wise direction of the turn portion 23a on the bending outside of the bent part, but contracted in the length-wise direction and thickened in the width-wise direction of the turn portion 23a on the bending inside of the same.

Further, referring to FIG. 14C, when the turn portion 23a is not pressed in its thickness-wise direction by the pressing plate 27 during the shaping process, the insulator 23c bulges in the thickness-wise direction of the turn portion 23a. As a result, the thicknesses of the insulator 23c for the side surfaces of the bent part perpendicular to the thickness-wise direction of the turn portion 23a become greater than the thicknesses W3 and W5 shown in FIG. 14B.

In other words, in the present embodiment, the insulator 23c is suppressed by the suppressing mechanism of the electric wire shaping apparatus 10 from bulging in the thickness-wise direction of the turn portion 23a, resulting in the reduced thicknesses W3 and W5.

According to the present embodiment, it is possible to achieve the following advantages.

In the present embodiment, the electric wire shaping apparatus 10 includes a shaping mechanism and the coil pitch keeping mechanisms 18 and 25. The shaping mechanism is configured to press the turn portion 23a of the electric wire 23 in its width-wise direction (i.e., in the direction D2 shown in FIGS. 1 and 2), thereby shaping the turn portion 23a to have the stepped shape. More specifically, the shaping mechanism is comprised of the pair of male and female shaping dies 20 and 15 and a pressing mechanism. Further, the pressing mechanism is comprised of the driving mechanism, the moving plate 11, the protruding members 14, 28, 17, and 26, and the moving bed 21. The pressing mechanism is configured to move the male shaping die 20 toward the female shaping die 15, thereby pressing the turn portion 23a of the electric wire 23 in its width-wise direction between the shaping surfaces 20a and 15a of the male and female dies 20 and 15. On the other hand, the coil pitch keeping mechanisms 18 and 25 are configured to respectively press the straight portions 23b of the electric wire 23 toward the inside space between the straight portions 23b (i.e., in the directions D4 and D5 shown in FIG. 9), thereby preventing the interval P between the straight portions 23b from being changed by the pressing of the turn portion 23a by the shaping mechanism.

With the above configuration, it is possible for the electric wire shaping apparatus 10 to shape the turn portion 23a of the electric wire 23 to have the stepped shape, while preventing the interval P between the straight portions 23b from being changed. Consequently, the straight portions 23b can be reliably placed into the corresponding slots of the stator core in a subsequent process of assembling the stator coil to the stator core.

In the present embodiment, each of the coil pitch keeping mechanisms 18 and 25 includes a force converter and the pressing block 30. The force converter is comprised of the oblique surface 30c of the pressing block 30 and the oblique surface 31a of the guiding block 31. The force converter converts a force transmitted to the guiding block 30 in the width-wise direction of the turn portion 23a of the electric wire 23 (i.e., in the direction D2 shown in FIGS. 1 and 2) to a force in a direction toward the inside space between the straight portions 23b of the electric wire 23 (i.e., in the direction D4 or D5 shown in FIG. 9). The pressing block 30 presses a corresponding one of the straight portions 23b toward the inside space between the straight portions 23b with the force obtained from the force conversion by the force converter.

With the above configuration, the coil pitch keeping mechanisms 18 and 25 can share a common power source with the shaping mechanism of the electric wire shaping apparatus 10. Consequently, it is possible to simplify the overall configuration and thus decrease the manufacturing cost of the electric wire shaping apparatus 10.

In the present embodiment, the pressing block 30 of each of the coil pitch keeping mechanisms 18 and 25 presses the corresponding straight portion 23b of the electric wire 23 to lean toward the inside space between the straight portions 23b by the angle θ3.

Consequently, despite the springback of the straight portions 23b, it is possible to reliably prevent the interval P between the straight portions 23b from being changed by the pressing of the turn portion 23a.

In the present embodiment, the electric wire shaping apparatus 10 further includes the suppressing mechanism that is comprised of the pressing plate 27 and the elastic members 12 and 13. During the pressing of the turn portion 23a in its width-wise direction by the shaping mechanism, the pressing plate 27 presses, under the elastic forces of the elastic members 12 and 13, the turn portion 23a of the electric wire 23 in its thickness-wise direction.

Consequently, with the suppressing mechanism, it is possible to suppress the turn portion 23a of the electric wire 23 from bulging in the thickness-wise direction during the pressing of the turn portion 23a in the width-wise direction by the shaping mechanism. As a result, the electric wire 23 can be reliably assembled with other identically-shaped electric wires to form the stator coil. In addition, with the above configuration of the suppressing mechanism, it is possible to provide the suppressing mechanism at low cost.

In the present embodiment, the electric wire shaping apparatus 10 shapes the turn portion 23a of the electric wire 23 to have the stepped shape.

With the stepped shape of the turn portion 23a, it is possible to reduce the height of the coil ends of the stator coil, thereby reducing the axial length of the electric rotating machine.

While the above particular embodiment of the present invention has been shown and described, it will be understood by those skilled in the art that various modifications, changes, and improvements may be made without departing from the spirit of the invention.

### [Modification 1]

In the previous embodiment, the turn portion 23a of the electric wire 23 is shaped by the electric wire shaping apparatus 10 to have the stepped shape as shown in FIGS. 13A-13B. However, by modifying the shaping surfaces 20a and 15a of the male and female shaping dies 20 and 15, it is possible for the electric wire shaping apparatus 10 to shape the turn portion 23a to have other shapes. For example, the turn portion 23 may be curved instead of being stepped. Otherwise, it is also possible for the turn portion 23a to be partially stepped and partially curved.

### [Modification 2]

In the previous embodiment, the pressing mechanism is configured to move the male shaping die 20 toward the female shaping die 15, thereby pressing the turn portion 23a of the electric wire 23 between the shaping surfaces 20a and 15a of the male and female shaping dies 20 and 15. However, the pressing mechanism may also be configured to move the female shaping die 15 toward the male shaping die 20, thereby pressing the turn portion 23a between the shaping surfaces 20a and 15a.

### [Modification 3]

In the previous embodiment, the elastic members 12 and 13 of the suppressing mechanism are implemented by the helical springs. However, the elastic members 12 and 13 may also be provided in other forms, such as rubber members and fluid springs.

Moreover, the suppressing mechanism may also include a different number of the elastic members, for example one or three.

### [Modification 4]

In the previous embodiment, the force converter is comprised of the oblique surface 30c of the pressing block 30 and the oblique surface 31a of the guiding block 31. However, it is also possible to configure the force converter by other means, for example a rack and pinion mechanism.

### [Modification 5]

In the previous embodiment, the power transmission direction is changed from the vertical direction D1 to the horizontal direction D2 by means of the sliding contact between the inclined surfaces 14a and 17a of the protruding members 14 and 17 and between the inclined surfaces 28a and 26a of the protruding members 28 and 26. However, it is also possible to change the power transmission direction by other means, for example a rack and pinion mechanism.

### [Modification 6]

In the previous embodiment, the driving mechanism is configured to move the moving plate 11 toward the base 22, thereby causing the male shaping die 20 to move toward the female shaping die 15. However, the driving mechanism may also be configured to move the base 22 toward the moving plate 11, thereby causing the male shaping die 20 to move toward the female shaping die 15.

### [Modification 7]

In the previous embodiment, the insulator 23c of the electric wire 23 is formed in a single layer. However, the insulator 23c may also be formed in two layers. In this case, the inner and outer layers of the insulators 23c may be respectively made of, for example, enamel and PPS.

What is claimed is:

1. An electric wire shaping apparatus for shaping a turn portion of an electric wire for a stator coil of an electric rotating machine,
wherein the turn portion of the electric wire is to be located outside of slots of a stator core of the electric rotating machine and connects a pair of straight portions of the electric wire, and
the straight portions of the electric wire extend parallel to each other with a predetermined interval therebetween and are to be respectively received in two of the slots of the stator core, the interval between the straight portions defining a coil pitch of the stator coil,
the electric wire shaping apparatus comprising:
a shaping mechanism that presses the turn portion of the electric wire in a width-wise direction of the turn portion, thereby shaping the turn portion to have a desired shape; and
a pair of coil pitch keeping mechanisms that respectively press the straight portions of the electric wire toward the inside space between the straight portions, thereby preventing the interval between the straight portions from being changed by the pressing of the turn portion by the shaping mechanism.

2. The electric wire shaping apparatus as set forth in claim 1, wherein each of the coil pitch keeping mechanisms comprises:
a force converter that converts a force transmitted to the coil pitch mechanism in the width-wise direction of the turn portion into a force in a direction toward the inside space between the straight portions; and
a pressing block that presses a corresponding one of the straight portions with the force in the direction toward the inside space between the straight portions.

3. The electric wire shaping apparatus as set forth in claim 1, wherein each of the coil pitch keeping mechanisms presses a corresponding one of the straight portions of the electric wire to lean toward the inside space between the straight portions by a predetermined angle.

4. The electric wire shaping apparatus as set forth in claim 1, further comprising a suppressing mechanism that presses the turn portion of the electric wire in a thickness-wise direction of the turn portion, thereby suppressing the turn portion from bulging in the thickness-wise direction during the pressing of the turn portion by the shaping mechanism.

5. The electric wire shaping apparatus as set forth in claim 4, wherein the suppressing mechanism comprises a pressing plate that presses the turn portion of the electric wire and at least one elastic member that applies an elastic force to the pressing plate in the thickness-wise direction of the turn portion toward the turn portion.

6. The electric wire shaping apparatus as set forth in claim 1, wherein the shaping mechanism comprises:
a pair of male and female shaping dies each of which has a shaping surface; and
a pressing mechanism that moves one of the male and female shaping dies toward the other, thereby pressing the turn portion of the electric wire between the shaping surfaces of the male and female shaping dies in the width-wise direction of the turn portion.

7. The electric wire shaping apparatus as set forth in claim 1, wherein the desired shape of the turn portion of the electric wire is a stepped shape.

8. The electric wire shaping apparatus as set forth in claim 1, wherein the electric wire is comprised of an electric conductor with a substantially rectangular cross section and an electric insulator that covers the electric conductor.

9. A method of shaping a turn portion of an electric wire for a stator coil of an electric rotating machine,
wherein the turn portion of the electric wire is to be located outside of slots of a stator core of the electric rotating machine and connects a pair of straight portions of the electric wire, and
the straight portions of the electric wire extend parallel to each other with a predetermined interval therebetween and are to be respectively received in two of the slots of the stator core, the interval between the straight portions defining a coil pitch of the stator coil,
the method comprising:
pressing the turn portion of the electric wire in a width-wise direction of the turn portion, thereby shaping the turn portion to have a desired shape; and
pressing the straight portions of the electric wire toward the inside space between the straight portions, thereby preventing the interval between the straight portions from being changed by the pressing of the turn portion in the width-wise direction.

10. The method as set forth in claim 9, wherein in the pressing of the straight portions, each of the straight portions of the electric wire is pressed to lean toward the inside space between the straight portions by a predetermined angle.

11. The method as set forth in claim 9, further comprising: pressing the turn portion of the electric wire in a thickness-wise direction of the turn portion, thereby suppressing the turn portion from bulging in the thickness-wise direction during the pressing of the turn portion in the width-wise direction.

12. The method as set forth in claim 9, wherein the desired shape of the turn portion of the electric wire is a stepped shape.

13. The method as set forth in claim 9, wherein the electric wire is comprised of an electric conductor with a substantially rectangular cross section and an electric insulator that covers the electric conductor.

14. An electric wire shaping apparatus for shaping a turn portion of an electric wire for a stator coil of an electric rotating machine,
wherein the electric wire is comprised of an electric conductor with a substantially rectangular cross section and an electric insulator that covers the electric conductor, and
the turn portion of the electric wire is to be located outside of slots of a stator core of the electric rotating machine and connects a pair of straight portions of the electric wire which are to be respectively received in two of the slots of the stator core,
the electric wire shaping apparatus comprising:
a shaping mechanism that presses the turn portion of the electric wire in a width-wise direction of the turn portion, thereby shaping the turn portion to have a desired shape; and
a suppressing mechanism that presses the turn portion of the electric wire in a thickness-wise direction of the turn portion, thereby suppressing the turn portion from bulging in the thickness-wise direction during the pressing of the turn portion by the shaping mechanism.

15. The electric wire shaping apparatus as set forth in claim 14, wherein the suppressing mechanism comprises a pressing plate that presses the turn portion of the electric wire and at least one elastic member that applies an elastic force to the pressing plate in the thickness-wise direction of the turn portion toward the turn portion.

16. The electric wire shaping apparatus as set forth in claim 14, wherein the shaping mechanism comprises:
a pair of male and female shaping dies each of which has a shaping surface; and
a pressing mechanism that moves one of the male and female shaping dies toward the other, thereby pressing the turn portion of the electric wire between the shaping surfaces of the male and female shaping dies in the width-wise direction of the turn portion.

17. The electric wire shaping apparatus as set forth in claim 14, wherein the desired shape of the turn portion of the electric wire is a stepped shape.

18. A method of shaping a turn portion of an electric wire for a stator coil of an electric rotating machine,
wherein the electric wire is comprised of an electric conductor with a substantially rectangular cross section and an electric insulator that covers the electric conductor, and
the turn portion of the electric wire is to be located outside of slots of a stator core of the electric rotating machine and connects a pair of straight portions of the electric wire which are to be respectively received in two of the slots of the stator core,
the method comprising:
pressing the turn portion of the electric wire in a width-wise direction of the turn portion, thereby shaping the turn portion to have a desired shape; and
pressing the turn portion of the electric wire in a thickness-wise direction of the turn portion, thereby suppressing the turn portion from bulging in the thickness-wise direction during the pressing of the turn portion in the width-wise direction.

19. The method as set forth in claim 18, wherein the desired shape of the turn portion of the electric wire is a stepped shape.
